(19) United States
(12) Patent Application Publication
(10) Pub. No.: US 2019/0319227 A1
(43) Pub. Date: Oct. 17, 2019

(54) COVER OF A POWER BATTERY AND METHOD OF MANUFACTURING THE SAME

(71) Applicant: TUNG-CHENG CHEN, TAICHUNG CITY (TW)

(72) Inventor: TUNG-CHENG CHEN, TAICHUNG CITY (TW)

(21) Appl. No.: 15/951,336

(22) Filed: Apr. 12, 2018

(51) Int. Cl. H01M 2/04; H01M 2/30; B29C 45/14

(52) U.S. Cl. CPC H01M 2/0473; B29L 2031/3468; B29C 45/14467; H01M 2/30

(57) ABSTRACT

A cover of a power battery has a plate, two electrodes, and two sealing pieces. The plate has two through holes disposed on the plate. The two electrodes are respectively engaged with the plate. The two sealing pieces are respectively mounted between the two electrodes and the plate, and are located between the two electrodes and the two through holes. Furthermore, the two sealing pieces are each formed integrally by an injection-molding step. The two sealing pieces allow the cover to isolate the outer space and the inner space of the power battery, and further to avoid air or liquid leakage. Moreover, the injection molding simplifies the assembly of the cover of a power battery, which makes the process of producing a cover of a power battery more efficient and more convenient. A manufacturing method of the cover of a power battery is also provided.

### BACKGROUND OF THE INVENTION

### 1. Field of the Invention

The present invention relates to a cover of a power battery and a manufacturing method thereof, and more particularly to a cover of a power battery that can make the power battery well-sealed without complicated assembly.

### 2. Description of Related Art

Power batteries are characterized by high capacity and high energy density. Consequently, power batteries have become the main power-supply technique for products which consume large amounts of energy, such as electric vehicles, vacuum cleaners, etc. As environmental consciousness rises and the energy revolution takes place, the rapid development of electric vehicles cause large demands for power batteries.

A conventional power battery comprises a shell, a battery module, and a cover. The shell has a chamber and an opening communicating with the chamber of the shell. The battery module is deposited in the chamber of the shell via the opening. The cover is detachably mounted to the shell to cover the opening of the shell, and is electrically connected to the battery module. Then, the battery module may connect with outer electrical components to supply electrical power.

With reference to FIG. 8, a cover of a conventional power battery comprises a base panel 60 and two electrodes 70. The base panel 60 has two through holes 601, two holding rings 61, two sealing elements 62, and two locking elements 63. The two through holes 601 are formed through the base panel 60 at a spaced interval. The two holding rings 61 are mounted to a lower surface of the base panel 60, and each holding ring 61 is engaged with a respective one of the two through holes 601. The two sealing elements 62 are respectively engaged with the two through holes 601, and each sealing element 62 is deposited between a corresponding holding ring 61 and the base panel 60. The two locking elements 63 are deposited on an upper surface of the base panel 60, and each locking element 63 is mounted around a respective one of the two through holes 601.

The two electrodes 70 are respectively a positive electrode and a negative electrode. Moreover, the two electrodes 70 are mounted to the base panel 60 and electrically connected to the battery module of the conventional power battery. Each electrode 70 serially passes through one of the two holding rings 61, a corresponding sealing element 62, and a corresponding through hole 601, and is fastened by a corresponding locking element 63.

By the assembly of the two holding rings 61, the two sealing elements 62, and the two locking elements 63, the cover is able to mount to the conventional power battery tightly and prevent air or liquid from passing through the cover of the conventional power battery.

However, the cover of the conventional power battery has the following shortcomings.

1. The assembly of the cover of the conventional power battery tends to be time-consuming due to the complicated structure and the series of the components.

2. There still exist gaps between each component and an adjacent component, and the leakage of air and liquid passing through the gaps may cause oxidization and rust to the battery module of the conventional power battery or outer electrical components.

### SUMMARY OF THE INVENTION

The main objective of the present invention is to provide a cover of a power battery and a manufacturing method thereof that has a preferred effect of leakage prevention and improves the complicated assembly of the cover of the conventional power battery.

The manufacturing method of a cover of a power battery comprises a preparing step and an injection-molding step. In the preparing step, prepare a plate and two electrodes, wherein the plate has two through holes formed through and disposed on the plate at a spaced interval, the two electrodes each respectively have a positive electrode and a negative electrode, and each electrode passes through a respective one of the two through holes. In the injection-molding step, put the plate and the two electrodes into a mold, wherein two sealing pieces made by molten plastic materials are respectively formed between the two electrodes and the plate, so as to mount the two electrodes to the plate, and become the product of the cover of a power battery.

The cover of a power battery is used to connect a battery module of the power battery and outer electrical components, and comprises a plate, two electrodes, and two sealing pieces. The plate has an upper surface, a lower surface, and two through holes. The two through holes are formed through the upper surface and the lower surface of the plate at a spaced interval. The two electrodes are respectively disposed in the two through holes of the plate, wherein each one of the two electrodes passes through a corresponding through hole and protrudes from the upper surface and the lower surface of the plate. The two sealing pieces are respectively mounted to the two electrodes and the plate, and each one of the two sealing pieces is deposited between a corresponding electrode and a corresponding through hole.

Other objectives, advantages and novel features of the invention will become more apparent from the following detailed description when taken in conjunction with the accompanying drawings.

### BRIEF DESCRIPTION OF THE DRAWINGS

FIG. 1 is a flow chart of a manufacturing method of a cover of a power battery in accordance with the present invention;

FIG. 2 is a partially exploded perspective view of a cover of a power battery in accordance with the present invention;

FIG. 3 is an operational and exploded perspective view of an injection-molding step to manufacture the cover in FIG. 2;

FIG. 4 is a partially enlarged cross sectional side view of the cover in FIG. 2;

FIG. 5 is a perspective view of the cover in FIG. 2;

FIG. 6 is another perspective view of the cover in FIG. 2;

FIG. 7 is a side view of the cover in FIG. 2; and

FIG. 8 is an exploded perspective view of a cover of a power battery in accordance with the prior art.

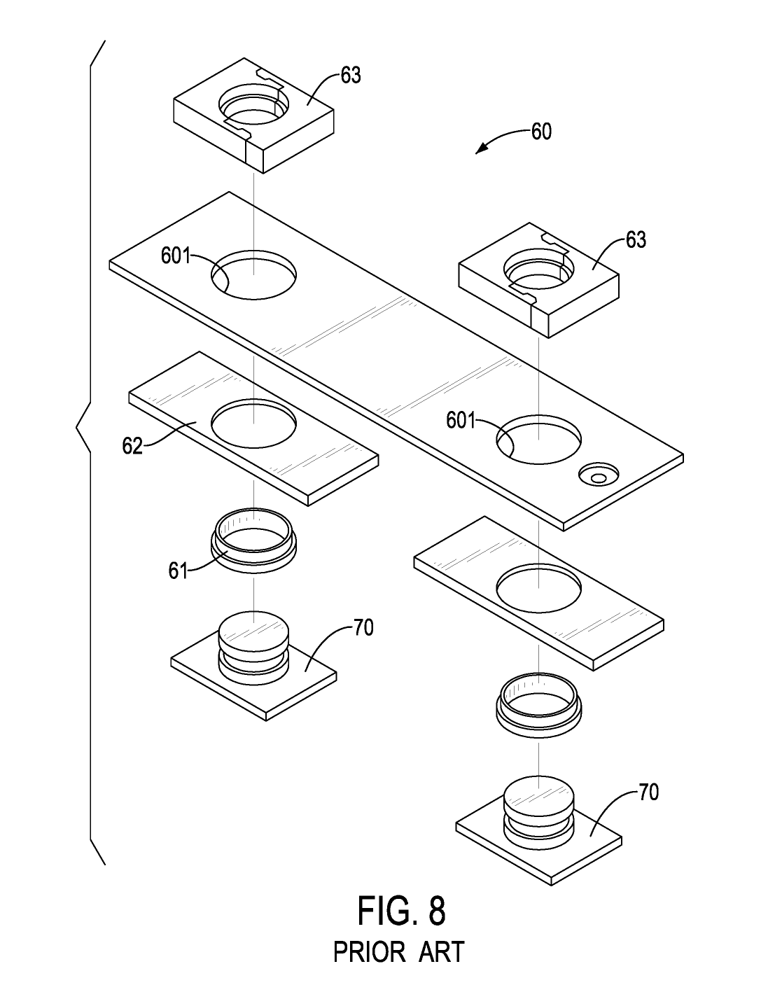

### DETAILED DESCRIPTION OF THE PREFERRED EMBODIMENT

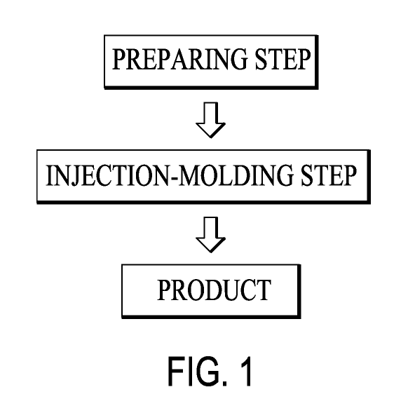

With reference to FIGS. 1 to 4, a preferred embodiment of a manufacturing method of a cover of a power battery in accordance with the present invention comprises the following steps:

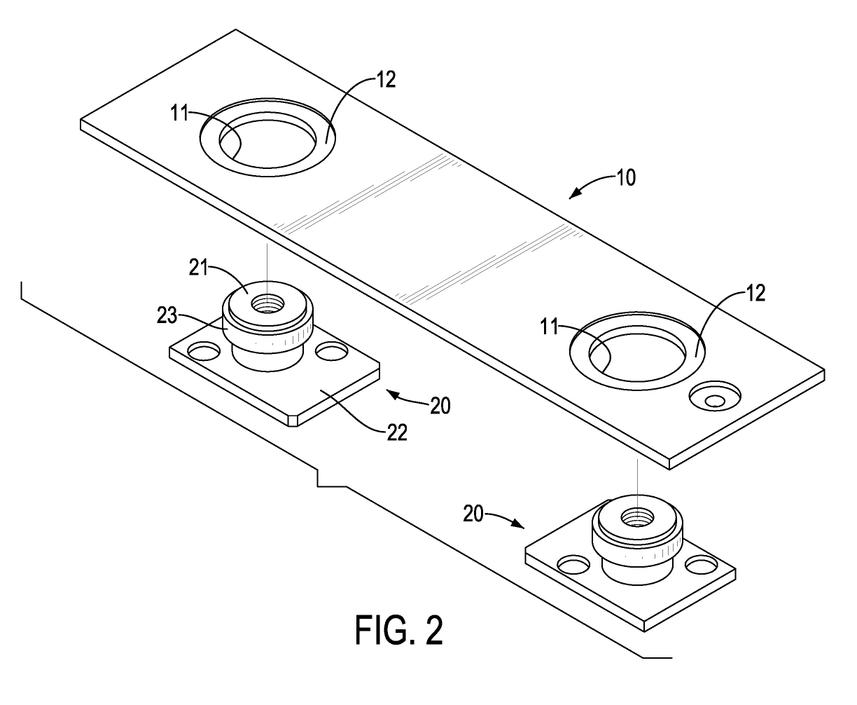

A. A preparing step: with reference to FIG. 2, firstly, prepare a plate 10 and two electrodes 20. The plate 10 has an upper surface, a lower surface, two through holes 11, and two grooves 12. The two through holes 11 are respectively formed through the upper surface and the lower surface of the plate 10, and are disposed on the plate 10 at a spaced interval. The two grooves 12 are formed in the upper surface of the plate 10, and respectively surround the two through holes 11. Furthermore, each groove 12 is concentric to a corresponding through hole 11.

The two electrodes 20 are mounted to the plate 10 and are respectively a positive electrode and a negative electrode. Each electrode 20 has two ends, an outer connector 21, and an inner connector 22. The outer connector 21 and the inner connector 22 are respectively located on the two ends of the electrode 20. The outer connector 21 comprises a screw recess 211 and a protruding part 23. The screw recess 211 is formed in a top end of the outer connector 21, and the protruding part 23 is annularly formed on and protrudes from the outer connector 21 adjacent to the top end of the outer connector 21. The inner connector 22 is deposited at the other end of the electrode 20 opposite to the outer connector 21.

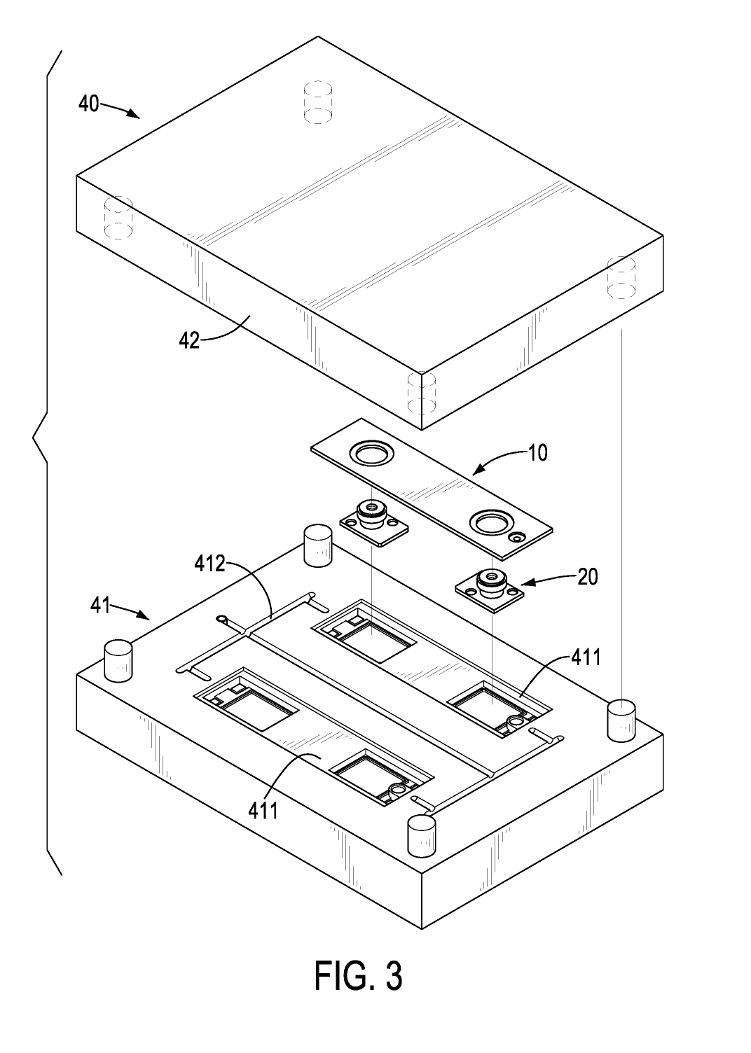

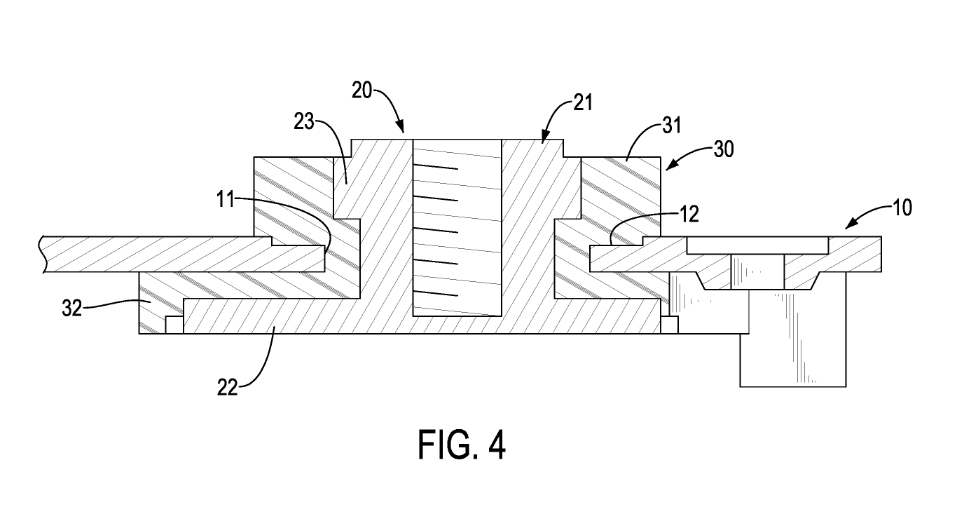

B. An injection-molding step: with reference to FIGS. 3 and 4, in the injection-molding step, mount the two electrodes 20 through the two through holes 11 of the plate 10 and the two electrodes 20. Prepare a mold 40 including a first half mold 41 and a second half mold 42 matching with the first half mold 41. The first half mold 41 has two cavities 411 located at a spaced interval and a flow path 412 communicating with the two cavities 411. When the plate 10 and the two electrodes 20 are engaged in one of the two cavities 411, the outer connector 21 of each electrode 20 passes through the corresponding through hole 11 from the lower surface of the plate 10. Therefore, the two electrodes 20 protrude from the upper surface and the lower surface of the plate 10 in the corresponding through holes 11, respectively. The injection-molding step will take place after the plate 10 and the two electrodes 20 are engaged in the two half molds 41, 42 of the mold 40 and the two half molds 41, 42 are then combined with each other. Molten plastic material will flow through the flow path 412 to enter each cavity 411, and eventually form a sealing piece 30 between each electrode 20 and the plate 10.

Gaps formed between the plate 10 and the two electrodes 20 are filled with plastic materials which compose the two sealing pieces 30. Therefore, the two sealing pieces 30 enable the preferred embodiment to isolate the outer space from the inner space of a power battery, and further to prevent air or liquid leakage from damaging the battery module of the power battery.

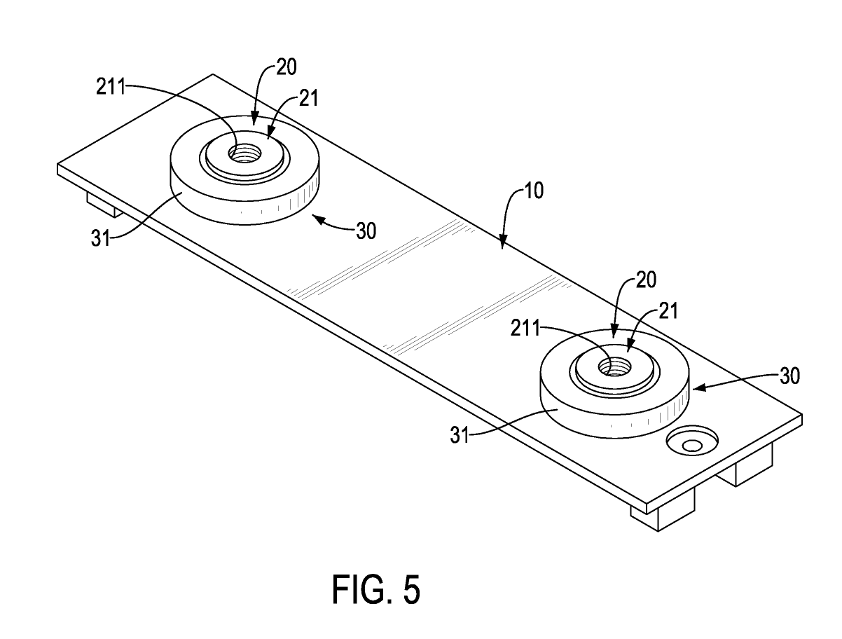

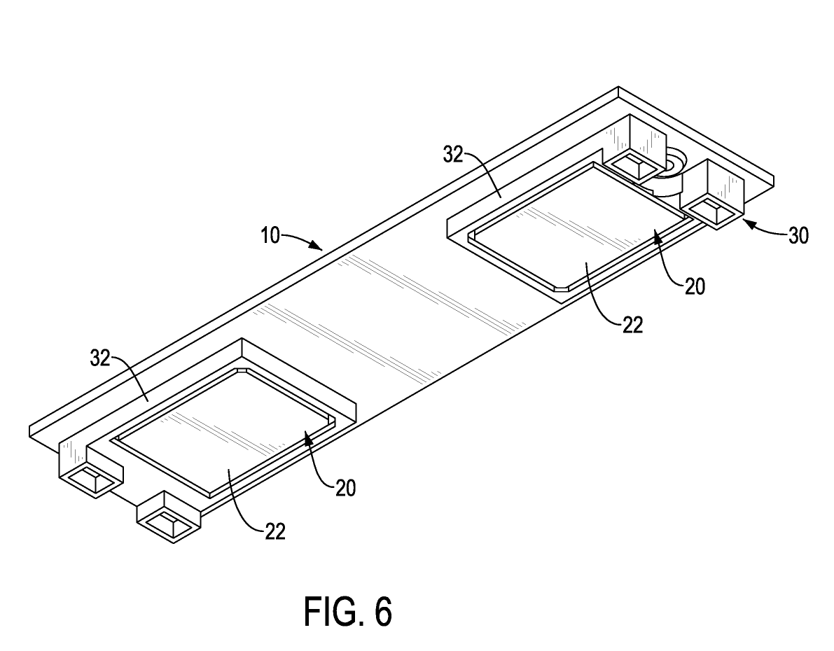

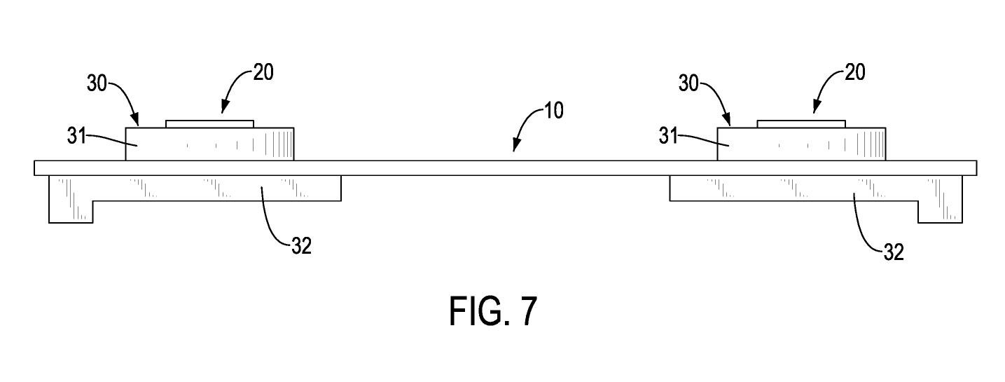

With reference to FIGS. 4 to 7, a preferred embodiment of a cover of a power battery in accordance with the present invention comprises a plate 10, two electrodes 20, and two sealing pieces 30.

The plate 10 is used to mount on a shell of a power battery and to cover an opening of the shell. The plate 10 has a lower surface, an upper surface, two through holes 11, and two grooves 12. The two through holes 11 are respectively formed through the upper surface and the lower surface of the plate 10, and are disposed on the plate 10 at a spaced interval. The two grooves 12 are formed in the upper surface of the plate 10, and respectively surround the two through holes 11 such that each groove 12 is concentric to a corresponding through hole 11.

The two electrodes 20 are mounted to the plate 10. The two electrodes 20 are respectively engaged in the two through holes 11 and protrude from the upper surface and the lower surface of the plate 10. Furthermore, the two electrodes 20 are respectively a positive electrode and a negative electrode. Each electrode 20 has two ends, an outer connector 21, and an inner connector 22. The outer connector 21 and the inner connector 22 are respectively located at the two ends of the electrode 20. The outer connector 21 protrudes from the upper surface and a corresponding groove 12 of the plate 10. The outer connector 21 comprises a screw recess 211 and a protruding part 23. The screw recess 211 is formed in a top end of the outer connector 21. The protruding part 23 is annularly formed on and protrudes from the outer connector 21 adjacent to the top end of the outer connector 21. Moreover, an outer diameter of the protruding part 23 is smaller than an inner diameter of a corresponding through hole 11. With reference to FIGS. 4 to 6, the inner connector 22 is a rectangular slice having an area that extends beyond the corresponding through hole 11.

With reference to FIGS. 4 to 7, the two sealing pieces 30 are respectively mounted between the plate 10 and the two electrodes 20. Each sealing piece 30 protrudes from the upper surface and the lower surface of the plate 10, and comprises an upper part 31 and a lower part 32. The upper part 31, which is located above the upper surface of the plate 10, encircles the protruding part 23 of a corresponding electrode 20, but the upper part 31 does not protrude from the top end of the outer connector 21. The lower part 32, which is located below the lower surface of the plate 10, protrudes from the lower surface of the plate 10 and surrounds the periphery of the inner connector 22, but the lower part 32 does not protrude from a bottom end of the inner connector 22.

With the aforementioned technical characteristics, the cover of a power battery and a manufacturing method thereof have the following advantages.

1. The two one-piece sealing pieces 30 allow the cover to isolate the outer space from the inner space of the power battery, and further to avoid air or liquid leakage.

2. Diameters differ among the protruding parts 23, the grooves 12, the through holes 11, and the inner connectors 22. And that makes the two sealing pieces 30 closely engaged with the plate 10 and the two electrodes 20, and further enhances the effect of leakage prevention.

3. In addition, the injection molding simplifies the complicated assembly of the conventional cover of a power battery, which makes the process of producing the cover of a power battery of the present invention more efficient and more convenient.

Even though numerous characteristics and advantages of the present utility model have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A manufacturing method of a cover of a power battery comprising the steps of:
a preparing step, preparing a plate and two electrodes, wherein the plate has two through holes formed through and disposed on the plate at a spaced interval, the two electrodes are respectively a positive electrode and a negative electrode, and each electrode passes through a respective one of the two through holes; and
an injection-molding step, putting the plate and the two electrodes into a mold, wherein molten plastic materials form a sealing piece mounted between each electrode and the plate.

2. The manufacturing method of a cover of a power battery as claimed in claim 1, wherein in the preparing step, two grooves are formed in a surface of the plate respectively surrounding the two through holes.

3. The manufacturing method of a cover of a power battery as claimed in claim 1, wherein in the preparing step, each electrode forms an outer connector and an inner connector at the two ends of the electrode, respectively.

4. The manufacturing method of a cover of a power battery as claimed in claim 2, wherein in the preparing step, each electrode forms an outer connector and an inner connector at the two ends of the electrode, respectively.

5. The manufacturing method of a cover of a power battery as claimed in claim 3, wherein in the preparing step, the inner connector of each electrode forms a rectangular slice that extends beyond a corresponding through hole.

6. The manufacturing method of a cover of a power battery as claimed in claim 4, wherein in the preparing step, the inner connector of each electrode forms a rectangular slice that extends beyond a corresponding through hole.

7. The manufacturing method of a cover of a power battery as claimed in claim 3, wherein in the preparing step, the outer connector of each electrode radially protrudes from and forms a protruding part near an end of the outer connector.

8. The manufacturing method of a cover of a power battery as claimed in claim 4, wherein in the preparing step, the outer connector of each electrode radially protrudes from and forms a protruding part near an end of the outer connector.

9. A cover of a power battery, the cover comprising:
a plate having an upper surface, a lower surface, and two through holes, wherein the two through holes are formed through the upper surface and the lower surface of the plate at a spaced interval;
two electrodes engaged with the plate, and each one of the two electrodes passing through a respective one of the two through holes and protruding from the upper surface and the lower surface of the plate; and
two sealing pieces respectively mounted to the two electrodes and the plate, and each sealing piece encircling a corresponding one of the electrodes and located between the corresponding electrode and the plate.

10. The cover of a power battery as claimed in claim 9, wherein the plate has two grooves, and the two grooves are formed in the upper surface of the plate and respectively surround the two through holes.

11. The cover of a power battery as claimed in claim 9, wherein each electrode has an outer connector and an inner connector, and the two connectors are formed on two ends of the electrode.

12. The cover of a power battery as claimed in claim 10, wherein each electrode has an outer connector and an inner connector, and the two connectors are formed on two ends of the electrode.

13. The cover of a power battery as claimed in claim 11, wherein the inner connector of each electrode forms a rectangular slice that extends beyond a corresponding through hole.

14. The cover of a power battery as claimed in claim 12, wherein the inner connector of each electrode forms a rectangular slice that extends beyond a corresponding through hole.

15. The cover of a power battery as claimed in claim 11, wherein each electrode has a protruding part, and the protruding part radially protrudes near the end of the outer connector.

16. The cover of a power battery as claimed in claim 12, wherein each electrode has a protruding part, and the protruding part radially protrudes near the end of the outer connector.
